(19) United States
(12) Patent Application Publication
(10) Pub. No.: US 2017/0226958 A1
(43) Pub. Date: Aug. 10, 2017

(54) Spring Energized Cylinder Liner Seal

(71) Applicant: Caterpillar Inc., Peoria, IL (US)

(72) Inventors: Jay H. Cline, Hopewell, IL (US); Sarfraz Alam, Peoria, IL (US)

(73) Assignee: Caterpillar Inc., Peoria, IL (US)

(21) Appl. No.: 15/040,369

(22) Filed: Feb. 10, 2016

(51) Int. Cl. F02F 11/00; F16J 15/02; F02F 1/00; F16J 10/04

(52) U.S. Cl. CPC F02F 11/005; F16J 10/04; F16J 15/022; F02F 1/004

(57) ABSTRACT

A seal assembly that includes a substantially annular cylindrical configuration that defines an aperture that defines a cylindrical axis and a radial direction is provided. The seal assembly comprises a spring member that includes two arm portions that extend substantially in a direction that is parallel to the cylindrical axis and that meet forming a flex point, and a sealing member that at least partially encapsulates the spring member and that includes: a first sealing feature, and a second sealing feature that is positioned axially and radially adjacent the flex point of the spring member and that faces in a direction that is diametrically opposite the direction that the first sealing feature faces along the radial direction, and an elastomeric material that includes a base resistant type 5 fluoroleastomer made from a copolymer of propylene and tetrafluoroethylene.

### TECHNICAL FIELD

The present disclosure relates generally to spring energized seals. More specifically, the present disclosure relates to spring energized seals for use with sealing the cylinder liners or sleeves of a combustion engine and the like.

### BACKGROUND

Internal combustion engines typically use seals to prevent the leaking of liquids and gases from the various components of the engine. One application includes the use of a seal that prevents the leaking of coolant that circulates around the cylinder liner of a cylinder in the engine. This seal is often disposed in a groove located between the cylinder liner and the cylinder block of the engine.

One skilled in the art can appreciate that this environment may be particularly harsh due to the temperature extremes (including hot and cold) such seals may experience as well as the corrosive agents such as exhaust and coolants that the seals are exposed to over time. This may lead to the failure of the seal and require the seal to be replaced, leading to downtime for the engine and unwanted costs.

Moreover, large bore heavy duty engines are requiring a longer life between engine rebuilds and overhauls, which is the best time to replace such seals without incurring the unwanted costs just mentioned. Current elastomer liner seals may not always meet the desired life and temperature requirements of such applications. Likewise, the current materials used in such seals may not resist the chemical attack of all the fluids to which they may become exposed. Consequently, the seals may fail and be unable to maintain the necessary sealing force before scheduled maintenance, which is undesirable.

Therefore, it is desirable to develop a seal for such applications that is more robust than has yet been devised.

### SUMMARY OF THE DISCLOSURE

A seal assembly is provided that defines an aperture, that the aperture defines defining a longitudinal axis and a radial direction that is perpendicular to the longitudinal axis. The seal assembly comprises a spring member, and a sealing member that at least partially encapsulates the spring member and that includes: a perimeter that runs in a plane that is parallel to both the longitudinal axis and the radial direction perpendicular to the longitudinal axis, and thatthat the perimeter defines defining a first axial extremity and a second axial extremity, a first sealing surface that runs paralleloriented parallel to the longitudinal axis, and a sealing feature that is positioned axially between the first and second axial extremities, and that faces in athe sealing feature positioned diametrically opposite direction than the direction the and facing away from the first sealing surface faces along the direction that is perpendicular to the longitudinal axis in the radial direction.

A seal assembly that includes a substantially annular cylindrical configuration that defines an aperture that defines a cylindrical axis and a radial direction is provided. The seal assembly comprises a spring member that includes two arm portions that extend substantially in a direction that is parallel to the cylindrical axis and that meet forming a flex point, and a sealing member that at least partially encapsulates the spring member and that includes: a first sealing feature, and a second sealing feature that is positioned axially and radially adjacent the flex point of the spring member and that faces in a direction that is diametrically opposite the direction that the first sealing feature faces along the radial direction, and an elastomeric material that includes a base resistant type 5 fluoroleastomer made from a copolymer of propylene and tetrafluoroethylene.

An engine assembly is provided that comprises an engine block that includes a bore, a cylinder liner disposed in the bore and that defines an annular groove, and a seal assembly disposed in the annular groove that defines a cylindrical axis and a radial direction, the seal assembly including a spring member that includes two arm portions that extend substantially in a direction that is parallel to the cylindrical axis and that meet forming a flex point, and a sealing member that at least partially encapsulates the spring member and that includes: a first sealing feature, and a second sealing feature that is positioned axially and radially adjacent the flex point of the spring member and that faces in a direction that is diametrically opposite the direction that the first sealing feature faces along the radial direction, and an elastomeric material that includes a base resistant type 5 fluoroleastomer made from a copolymer of propylene and tetrafluoroethylene.

### BRIEF DESCRIPTION OF THE DRAWINGS

FIG. 1 is a perspective view of seal assembly according to one embodiment of the present disclosure.

FIG. 2 is a cross-sectional view of the seal assembly of FIG. 1 taken along lines 2-2 thereof.

FIG. 3 is a front view of the cross-section of FIG. 2, showing how the seal assembly may be constructed and assembled.

FIG. 4 is a perspective view of an engine assembly that includes a cross-section showing an interface between a cylinder liner and the engine block that may employ the seal assembly of FIG. 1.

FIG. 5 is an enlarged front view of the cross-section of the engine assembly of FIG. 4 showing the seal assembly of FIG. 1 disposed in annular groove located about the perimeter of the cylinder liner and that seals between the liner and the engine block, preventing the leaking of coolant flowing in the groove disposed under the seal and about the perimeter of the bore of the engine block and the perimeter of the liner.

### DETAILED DESCRIPTION

In some embodiments as will be discussed, a new cylinder sleeve seal assembly is provided that uses a metal spring to help recover loses in sealing force due to elastic relaxation. As a result, the seal assembly will typically seal well at the most severe cold temperatures. Furthermore, a material is selected for the sealing member that includes a base resistant type 5 fluoroleastomer made from a copolymer of propylene and tetrafluoroethylene. This material may be able to resist the chemical attack associated with basic engine coolants of all types.

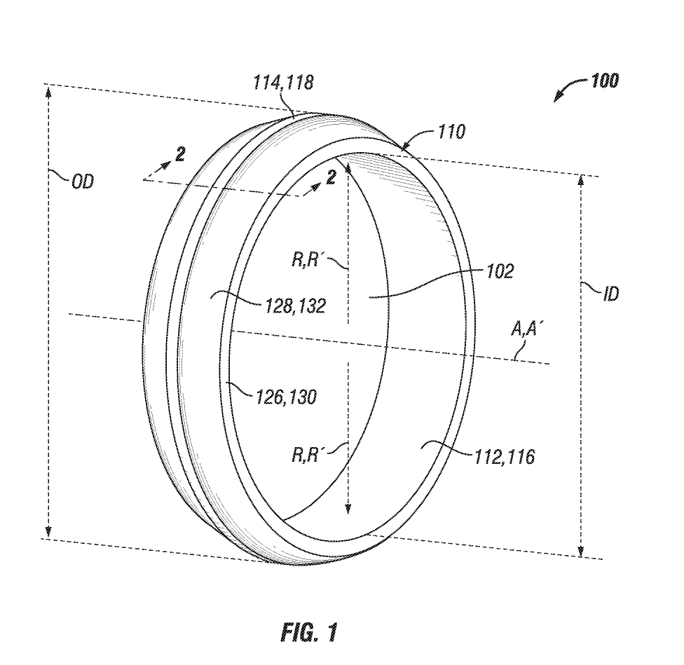

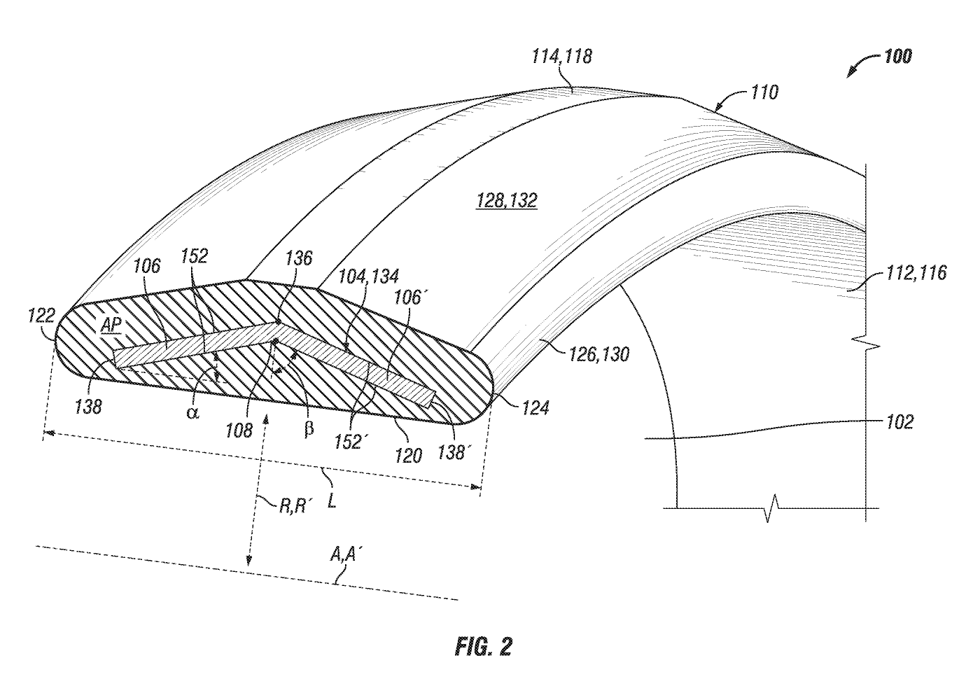

Looking at FIGS. 1 and 2, a seal assembly 100 that includes a substantially annular cylindrical configuration according to an embodiment of the present disclosure is shown. The seal assembly 100 defines an aperture 102 that defines a cylindrical axis A and a radial direction R. Also, the seal assembly 100 comprises a spring member 104 that includes two arm portions 106, 106′ that extend substantially in a direction that is parallel to the cylindrical axis A and that meet forming a flex point 108. A sealing member 110 is provided that encapsulates the spring member 104 and that includes a first sealing feature 112 and a second sealing feature 114 that is positioned axially and radially adjacent the flex point 108 of the spring member 104 and that is diametrically opposite the first sealing feature 112 along the radial direction R. The relative placement of the flex point 108 to the second sealing feature 114 means that the second sealing feature 114 is biased radially outward by the spring member 104 and that the sealing force is maximized locally where a seal is meant to be provided by the second sealing feature.

While this embodiment has an annular cylindrical configuration, other embodiments may have other configurations. For example, the annular configuration may be polygonal, etc. In such embodiments, the cylindrical axis A would be replaced by a longitudinal axis A′ and the radial direction R would be replaced by another direction R′ that is perpendicular to the longitudinal axis A′.

A sealing feature of any embodiment may have any configuration known or that will be devised in the art such as an edge or lip, a flat surface, etc. For this embodiment, the first sealing feature 112 is an inner sealing surface 116 that is substantially flat in an axial direction and that runs parallel to the cylindrical axis A. The first sealing feature 112 may alternatively be provided with other surface features, such as, for example, undulations extending in the axial or circumferential directions. Similarly, the second sealing feature 114 is a second sealing surface, referred to as an outer sealing surface 118 that is substantially flat and that runs parallel to the cylindrical axis A. In other words, the first sealing feature is oriented parallel to the longitudinal axis or cylindrical axis A. It is contemplated that since the outer sealing surface is relatively short in length along the cylindrical axis, that it may be replaced by a lip or edge. The inner sealing surface 116 is so called as it faces toward the cylindrical axis A and the outer sealing surface 118 is so called as it faces away from the cylindrical axis A.

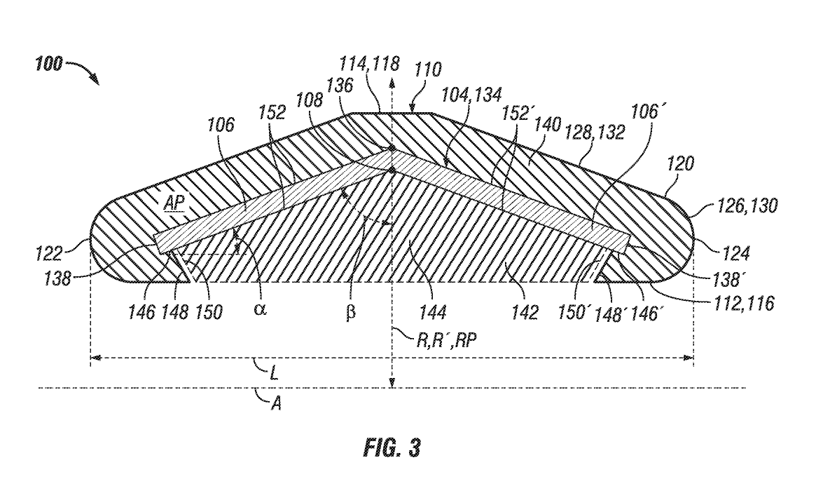

As best seen in FIGS. 2 and 3, the sealing member 110 includes a perimeter 120, shown in cross-section, which runs in an axial plane AP that defines a first axial extremity 122 and a second axial extremity 124. The sealing member 110 further comprises at least one transitional surface 126 that is interposed between the first sealing feature 112 and the second sealing feature 114 along the perimeter 120 of the sealing member 110. In particular for this embodiment, the sealing member 110 comprises at least two transitional surfaces 126, 128 that are interposed between the first sealing feature 112 and the second sealing feature 114. The transitional surfaces connect with each other and the first and second sealing features in an uninterrupted manner for this embodiment, but this may not be the case for other embodiments. The transitional surface 126 that connects to the first sealing feature 112 is a blend 130 and the transitional surface 128 that connects to the second sealing feature 114 is an angled surface 132. Other transitional surfaces may be used. It should be noted that very small radii or blends may be present between surfaces to avoid sharp corners are being ignored herein when discussing transition surfaces and their connection to sealing features as they essentially represent the intersection of one surface to another.

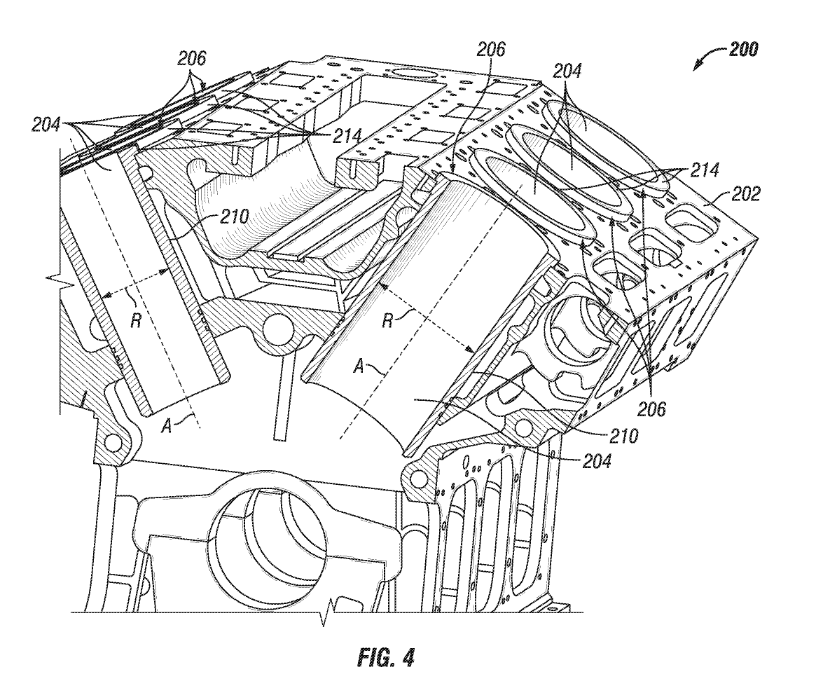

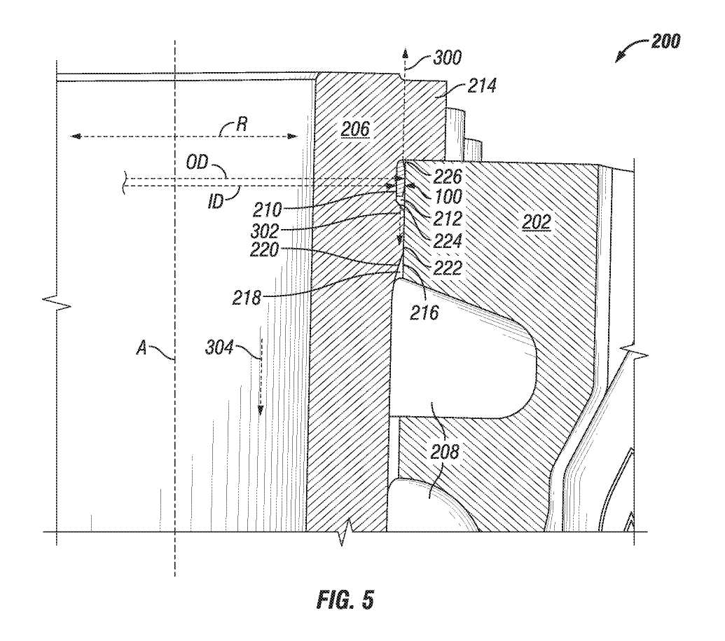

As will be seen later herein with reference to FIGS. 4 and 5, these surfaces 126, 128 facilitate the assembly of the seal assembly 100 into an engine assembly that includes the cylinder liner and engine block. The second sealing feature 114 is positioned substantially equidistantly from the axial extremities 122, 124 along the cylindrical axis A. This may not be true for other embodiments.

As mentioned previously and best seen with reference to FIGS. 2 and 3, the arm portions 106, 106′ of the spring member 104 extend substantially in a direction parallel to the cylindrical axis A as the acute angle α they form with this direction is less than the acute angle β they form with the radial direction R. These angles may be varied as needed or desired but angle α may range from 10 to 20 degrees for some embodiments. The arm portions 106, 106′ of the spring member 104 comprise flat surfaces 152 that meet forming substantially a chevron configuration 134. For this embodiment, this creates a sharp corner 136 however it is contemplated that a blend may exist between the arm portions in other embodiments such that the flex point 108 and sharp corner 136 are curved. Also, the free ends 138, 138′ of the arm portions 106, 106′ are located adjacent the opposite axial extremities 122, 124 along a direction that is parallel to the axis A. Arm portions 106, 106′ may be completely straight, such as having flat surfaces 152, or may have undulations, be curved, etc. provided that they establish a sweep direction that is substantially straight. That is to say, a line may be drawn from the free end 138 to the sharp corner 136 or flex point 108 that is substantially straight and these lines form a non-parallel angle relative to each other. Put another way, angle β would not be ninety degrees.

Furthermore, as best seen in FIG. 3, the seal assembly 100 defines a radial plane RP that is parallel to the radial direction R and perpendicular to the cylindrical axis A and the seal assembly 100 is substantially symmetrical about the radial plane RP. This allows the seal assembly 100 to be rotated 180 degrees about a radial direction R and still be assembled into an engine block assembly as will be described momentarily. This may not be true for other embodiments. Furthermore, the cross-sections shown in FIGS. 2 and 3 are consistent around the entire perimeter of the seal assembly. That is to say, the seal assembly may be created by rotating the cross-sections of FIGS. 2 and 3 completely around the cylindrical axis A. This may not be true for other embodiments.

Focusing more closely on FIG. 3, this figure illustrates how the seal assembly 100 may be assembled and the spring member 104 encapsulated by the sealing member 110. First, a two piece sealing member 110 is provided that includes a keeper member 140 that has retention features that hold onto the spring member 104 and covers the outer surfaces of the spring member 104 and a plug 142 that fills in the void 144 and covers the inner surfaces of the spring member 104. The retention features of the keeper member 140 includes an undercut that provides a ledge 146, 146′ into which the ends 138, 138′ of the spring member 104 may be snapped. Another undercut may also be provided with a ledge 148, 148′ that allows a complimentary surface 150, 150′ of the plug 142 to be snapped into place. Then the plug 142 may be bonded to the keeper member 140. The configuration of the various components and the method of connecting them may be varied. The specific structure disclosed in FIG. 3 is by way of an example only.

Alternatively, a material may be poured or injected into the void and hardened, cured, or bonded to the keeper member and/or the spring member. In some embodiments, the void will be not be filled. In such an embodiment, the first sealing feature 112 will be interrupted from one axial extremity 124 of the seal assembly 100 to the other axial extremity 122 and will have a smaller length along the cylindrical axis A, similar to that of the second sealing feature 114. Also, the perimeter 120 of the cross-section will be open instead of closed. Thus, the sealing member would only partially encapsulate the spring member.

For the various embodiments discussed herein, the spring member comprises a metal alloy and the sealing member comprises an elastomer. Other materials may be used for the spring member and the sealing member provided they have the desired characteristics to make the seal assembly perform for an intended application.

An exemplary list of materials that may be used for the spring member includes, but is not limited to, a metal, a metal alloy, a steel alloy, stainless steel, ceramic, cast blade alloy, cold formable super alloys, etc.

An exemplary list of materials that may be used for the sealing member includes, but is not limited to, FEP (fluorinated-ethylene propylene), PFA (perfluoroalkoxy), PTFE (polytetrafluoroethylene), ETFE (ethylenetetrafluoroethylene), PE (polyethylene), ETCFE, polyurethanes, a base resistant type 5 fluoroleastomer made from a copolymer of propylene and tetrafluoroethylene, peroxide cured fluorocarbon, ethylene-propylene copolymer, a hydrogenated butadiene-acrylonitrile copolymer, etc.

### INDUSTRIAL APPLICABILITY

The seal assembly 100 of FIGS. 1 and 2 is suitable for use with a host of industrial applications. One such application is illustrated by FIGS. 4 and 5 that includes the placement of the seal assembly in a groove of a cylinder sleeve that is installed into an engine block, helping to form an engine assembly. The engine may be sold with a seal assembly already installed in one or more cylinder liners. Alternatively, the seal assembly may be sold as a replacement part for maintaining engines in the field. The seal assembly may also may be manufactured and/or assembled by the end user, etc.

The seal assembly may be manufactured in any suitable manner including over molding the sealing member onto the spring member using an injection molding process or the like. Alternatively, the sealing member may be split into two pieces and assembled around the spring member such as shown and described previously with reference to FIG. 3. In some embodiments, the sealing member and spring member may be machined, assembled and then covered by another material to encase the spring member. The spring member may in some embodiments be bought or custom manufactured, etc. In yet other embodiments, the inner portion of the seal assembly may define a void that is left open or that is filled by a plug.

Looking back at FIGS. 1 and 2, the outer diameter OD and inner diameter ID of the seal assembly 100 are shown. For some embodiments such as those shown with respect to FIGS. 4 and 5, exemplary dimensions for the OD and ID are 186.28 mm and 184.71 mm respectively. Similarly as best seen in FIGS. 2 and 3, the seal assembly 100 defines a length L measured along the cylindrical axis A. For some embodiments such as those shown in FIGS. 4 and 5, an exemplary dimension is 5.82 mm. Of course, these dimensions may be varied as needed or desired depending upon the application.

FIG. 4 illustrates an engine assembly 200 that includes an engine block 202 that includes a V8 configuration where four cylinders 204 on each side form a V shape when looking at the engine assembly 200 from the front. Each of the cylinders 204 includes a cylinder liner 206 that is surrounded by a series of grooves 208 formed in the engine block 202 that provide a water jacket about the perimeter 210 of the cylinder liner 206 for cooling the cylinder 204 as heat builds up due to the repetition of combustion cycles. Although not clearly seen in FIG. 3 but shown in FIG. 4, a groove 212 is disposed about the perimeter 210 of the cylinder liner 206 proximate the flange 214 that is configured to hold a seal assembly 100 that is intended to prevent the leaking of coolant that circulates about the cylinder liner 206 past the seals 100 where it may infiltrate other parts of the engine, causing problems. Seal assemblies 100 may be provided on either side of the water jacket along the cylindrical axis A, preventing leaks in either direction. The location and configuration of the seal assemblies may be varied as needed or desired as well as the configuration of the engine block including the number and orientation of the cylinders.

FIG. 5 is an enlarged front view of the cross-section of the engine assembly 200 of FIG. 3 showing the seal assembly 100 of FIG. 1 disposed in annular groove 212 located about the perimeter 210 of the cylinder liner 206 and that seals between the liner 206 and the engine block 202, preventing the leaking of coolant flowing in the groove 208 disposed under the seal assembly 100 and about the perimeter 216 of the bore 218 of the engine block 202 and the perimeter of the liner. After being installed, the seal must maintain intimate contact with the engine block cylinder bore and liner groove inside diameter. The amount of seal compression may vary depending on the application, taking into consideration the forces required for assembly as well as the necessary sealing force to prevent any leakage from the system coolant pressure. Typically, the seal compression is designed to be within a range of 10 to 30 percent based on volume.

Looking more closely at FIG. 5, how the seal assembly 100 and cylinder liner 206 are assembled together and then placed into the bore 218 of the engine block 202 can be understood. First, the seal assembly 100 is assembled onto the cylinder liner 206 by sliding (step 300) the seal assembly 100 along the perimeter 210 of the cylinder liner 206 until it contacts a generous lead-in surface 220 that partially forms the ridge 222 that also partially forms the seal assembly retaining groove 212. This groove 212 is defined on one side by the ridge 222 and the other side by the flange 214 of the cylinder liner 206. As the seal assembly 100 contacts the lead-in surface 220, mechanical advantage is supplied as upward movement of the seal assembly 100 continues along the cylindrical axis A, expanding the seal assembly 100 so that it can pass over the ridge 222 and fall into the retaining groove 212.

Removal of the seal assembly by moving it downward (step 302) is hindered by the sloped surface 224 on the ridge 222 that has a steeper angle than that of the lead-in surface 220. This makes it more difficult to remove the seal assembly 100 than to install it, helping to prevent its unintentional removal. Of course, the removal of the seal assembly can be accomplished if enough force is supplied. In many embodiments, the upward movement (step 300) of the seal assembly 100 is continued until it impinges upon the flange 214.

Once the seal assembly 100 is installed into the groove 212, the cylinder liner 206 and the seal assembly 100 form a subassembly. Then, both are moved downward (step 304) into the appropriate bore 218 of the engine block 202. Though not shown in FIG. 5, one skilled in the art can appreciate that contact is eventually made between the seal assembly 100 and the corner or ledge 226 of the bore 218 of the engine block 202. This contact presses on the transitional surfaces 126, 128 of the seal assembly 100 and gradually causes the spring member 104 to move radially inwardly, all the while providing sealing force in the outward radial direction. This force continues and reaches its maximum once it outer sealing surface 118 is in contact with the perimeter 216 of the bore 218 of the engine block 202. The force necessary to compress the spring member may also cause movement of the seal assembly 100 upwards until it impinges or even slightly compresses against the flange 214 of the cylinder liner 206. This downward movement of the cylinder liner 206 continues until the flange 214 contacts the top surface of the engine block 202. Disassembly may be achieved by reversing these steps.

While most of the embodiments discussed herein are cylinder liner applications, other engine and industrial applications are compatible with the use of the seal assemblies discussed herein and are therefore within the scope of the present disclosure.

It will be appreciated that the foregoing description provides examples of the disclosed design and function. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein.

It will be apparent to those skilled in the art that various modifications and variations can be made to the embodiments of the apparatus and methods of assembly as discussed herein without departing from the scope or spirit of the invention(s). Other embodiments of this disclosure will be apparent to those skilled in the art from consideration of the specification and practice of the various embodiments disclosed herein. For example, some of the equipment may be constructed and function differently than what has been described herein and certain steps of any method may be omitted, performed in an order that is different than what has been specifically mentioned or in some cases performed simultaneously or in sub-steps. Furthermore, variations or modifications to certain aspects or features of various embodiments may be made to create further embodiments and features and aspects of various embodiments may be added to or substituted for other features or aspects of other embodiments in order to provide still further embodiments.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A seal assembly that defines an aperture, the aperture defining a longitudinal axis and a radial direction that is perpendicular to the longitudinal axis, the seal assembly comprising:
a spring member; and
a sealing member that at least partially encapsulates the spring member and includes:
a perimeter that runs in a plane that is parallel to both the longitudinal axis and the radial direction perpendicular to the longitudinal axis, the perimeter defining a first axial extremity and a second axial extremity;
a first sealing surface oriented parallel to the longitudinal axis; and
a sealing feature positioned axially between the first and second axial extremities, the sealing feature positioned diametrically opposite and facing away from the first sealing surface in the radial direction.

2. The seal assembly of claim 1 wherein the first sealing surface is an inner sealing surface that is substantially flat.

3. The seal assembly of claim 1 wherein the sealing feature is a second sealing surface that is an outer sealing surface that is substantially flat.

4. The seal assembly of claim 1, further comprising at least one transitional surface that is interposed between the first sealing surface and the sealing feature along the perimeter of the sealing member.

5. The seal assembly of claim 4, further comprising at least two transitional surfaces that are interposed between the first sealing surface and the sealing feature, wherein the transitional surfaces connect with each other and the sealing surface and the sealing feature in an uninterrupted manner, and the transitional surface that connects to the first sealing surface is a blend and the transitional surface that connects to the sealing feature is an angled surface.

6. The seal assembly of claim 1, wherein the sealing member comprises an elastomeric material that includes a base resistant type 5 fluoroleastomer made from a copolymer of propylene and tetrafluoroethylene.

7. The seal assembly of claim 1 wherein the spring member includes two arm portions that form a substantially chevron configuration.

8. The seal assembly of claim 7 wherein the arm portions of the spring member meet forming a flex point and wherein the flex point is positioned axially adjacent the sealing feature.

9. The seal assembly of claim 1 wherein the spring member comprises a metal alloy and the sealing member comprises an elastomer.

10. A seal assembly that includes a substantially annular cylindrical configuration that defines an aperture that defines a cylindrical axis and a radial direction, the seal assembly comprising:
a spring member that includes two arm portions that extend substantially in a direction that is parallel to the cylindrical axis and that meet forming a flex point; and
a sealing member that at least partially encapsulates the spring member and that includes:
a first sealing feature;
a second sealing feature that is positioned axially and radially adjacent the flex point of the spring member and that faces in a direction that is diametrically opposite the direction that the first sealing feature faces along the radial direction; and
an elastomeric material that includes a base resistant type 5 fluoroleastomer made from a copolymer of propylene and tetrafluoroethylene.

11. The seal assembly of claim 10 wherein the first sealing feature is an inner sealing surface that is substantially flat and that runs parallel to the cylindrical axis.

12. The seal assembly of claim 10 wherein the second sealing feature is a second sealing surface that is an outer sealing surface that is substantially flat and that runs parallel to the cylindrical axis.

13. The seal assembly of claim 10, wherein the sealing member includes a perimeter that runs in an axial plane that defines a first axial extremity and a second axial extremity, the sealing member further comprising at least one transitional surface that is interposed between the first sealing feature and the second sealing feature along the perimeter of the sealing member.

14. The seal assembly of claim 13 further comprising at least two transitional surfaces that are interposed between the first sealing feature and the second sealing feature, wherein the transitional surfaces connect with each other and the first and second sealing features in an uninterrupted manner, and the transitional surface that connects to the first sealing feature is a blend and the transitional surface that connects to the second sealing feature is an angled surface.

15. The seal assembly of claim 14, wherein the second sealing feature is positioned substantially equidistantly from the axial extremities along the cylindrical axis.

16. The seal assembly of claim 10 wherein the arm portions of the spring member comprise flat surfaces that meet forming substantially a chevron configuration.

17. The seal assembly of claim 16 wherein the flat surfaces of the arm portions meet forming a sharp corner.

18. The seal assembly of claim 10 wherein the spring member comprises a metal alloy and the sealing member comprises an elastomer.

19. The seal assembly of claim 10 wherein the seal assembly defines a radial plane that is parallel to the radial direction and perpendicular to the cylindrical axis and the seal assembly is substantially symmetrical about the radial plane.

20. An engine assembly comprising:
an engine block that includes a bore,
a cylinder liner disposed in the bore and that defines an annular groove; and
a seal assembly disposed in the annular groove that defines a cylindrical axis and a radial direction, the seal assembly including:
a spring member that includes two arm portions that extend substantially in a direction that is parallel to the cylindrical axis and that meet forming a flex point; and
a sealing member that at least partially encapsulates the spring member and that includes:
a first sealing feature; and
a second sealing feature that is positioned axially and radially adjacent the flex point of the spring member and that faces in a direction that is diametrically opposite the direction that the first sealing feature faces along the radial direction; and
an elastomeric material that includes a base resistant type 5 fluoroleastomer made from a copolymer of propylene and tetrafluoroethylene.
